(19) United States
(12) Patent Application Publication
(10) Pub. No.: US 2021/0118315 A1
(43) Pub. Date: Apr. 22, 2021

(54) METHOD AND SYSTEM FOR DETERMINING EFFORT INDEX OF A USER IN LEARNING A CONCEPT

(71) Applicant: Akhil D. Kohli, Danville, CA (US)

(72) Inventor: Akhil D. Kohli, Danville, CA (US)

(21) Appl. No.: 16/654,746

(22) Filed: Oct. 16, 2019

(51) Int. Cl. G09B 7/02; G09B 5/06; G06Q 50/20

(52) U.S. Cl. CPC G09B 7/02; G06Q 50/20; G09B 5/065

(57) ABSTRACT

Disclosed herein is a method and system for determining an effort index of a user in learning a concept. The method comprises providing a content associated with a concept to user and predefined number of questions associated with content. The method comprises monitoring first parameters when the content is being viewed by the user and identifies a total parameter value. Thereafter, method comprises monitoring second parameters when the user is providing answer for each predefined question. Based on the monitoring, the method comprises identifying a total factor value. Thereafter, the method comprises identifying a reward value for the user based on monitoring third parameters associated with predefined questions. Further, the method comprises determining effort index of the user in learning concept based on total parameter value, total factor value, a predefined effort index value associated with user and the reward value.

### TECHNICAL FIELD

The present subject matter is generally related to data processing and more particularly, but not exclusively, to method and system for determining effort index in learning a concept.

### BACKGROUND

Organizational learning can be defined as the development of new knowledge or insights that have the potential to influence all elements of an organization. The organization may be a business organization or an educational institution and the like. Knowledge management can be defined as processing (i.e., acquisition, learning and application) of information to benefit the organization. Training users and educating them is becoming increasingly critical to the success of organization in today's modern global economy. As a requirement to remain competitive, organizations that operate in today's complex industries need users who remain knowledgeable in areas of expertise that serve the organization's ever-evolving strategic objectives. Therefore, it is important to train the user and monitor user performance to check if the training provided is utilized by the users effectively.

The existing learning solutions fail to monitor performance of learning solution or efforts put by the users in understanding concepts provided in training for achieving the underlying purpose of business strategies. The inability to accurately monitor performance metrics leaves organizations and their learning services with an inability to ensure service quality and also to make strategic decisions.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method for determining an effort index of a user in learning a concept. The method comprising providing a content associated with a concept to the user. Thereafter, the method comprises providing a predefined number of questions associated with the content.

The method comprises monitoring one or more first parameters when the content is being viewed by the user. Based on the monitoring, the method comprises identifying a total parameter value based on a parameter value of each of the one or more first parameters and based on a first predefined constant value. Thereafter, the method comprises monitoring one or more second parameters when the user is providing answer for each of the predefined number of questions. Based on the monitoring, the method comprises identifying a total factor value based on a factor value for each of the one or more second parameters. Thereafter, the method comprises identifying a reward value for the user based on monitoring one or more third parameters associated with the predefined number of questions. Further, the method comprises determining an effort index of the user in learning the concept based on the total parameter value, total factor value, a predefined effort index value associated with the user and the reward value.

Further, the present disclosure discloses a system for determining effort index of a user in learning a concept. The effort index determination system comprises a processor and a memory. The memory is communicatively coupled to the processor, wherein the memory stores the processor-executable instructions, which, on execution, causes the processor to provide a content associated with a concept to the user. The processor provides a predefined number of questions associated with the content. Thereafter, the processor monitors one or more first parameters when the content is being viewed by the user. Further, the processor identifies a total parameter value based on a parameter value of each of the one or more first parameters and based on a first predefined constant value. Once the total parameter value is identified, the processor monitors one or more second parameters when the user is providing answer for each of the predefined number of questions. Thereafter, the processor identifies a total factor value based on a factor value for each of the one or more second parameters and also identifies reward value for the user. The reward value is identified based on monitoring one or more third parameters associated with the predefined number of questions. Further, the processor determines an effort index of the user in learning the concept based on the total parameter value, total factor value, a predefined effort index value associated with the user and the reward value.

Furthermore, the present disclosure comprises a non-transitory computer readable medium including instructions stored thereon that when processed by at least one processor causes effort index determination system to provide a predefined number of questions associated with the content. Thereafter, the instructions causes the processor to monitor one or more first parameters when the content is being viewed by the user. Further, the instructions causes the processor to identify a total parameter value based on a parameter value of each of the one or more first parameters and based on a first predefined constant value. Once the total parameter value is identified, the instructions causes the processor to monitor one or more second parameters when the user is providing answer for each of the predefined number of questions. Thereafter, the instructions causes the processor to identify a total factor value based on a factor value for each of the one or more second parameters and also identifies reward value for the user. The reward value is identified based on monitoring one or more third parameters associated with the predefined number of questions. Further, the instructions causes the processor to determine an effort index of the user in learning the concept based on the total parameter value, total factor value, a predefined effort index value associated with the user and the reward value.

The foregoing summary is illustrative only and is not intended to be in any way limiting. In addition to the illustrative aspects, embodiments, and features described above, further aspects, embodiments, and features will become apparent by reference to the drawings and the following detailed description.

### DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for determining an effort index of a user in learning a concept in accordance with some embodiments of the present disclosure;

FIG. 2a shows a detailed block diagram of an effort index determination system in accordance with some embodiments of the present disclosure;

FIGS. 2b-2c shows exemplary representations for indicating effort index in a display interface of a user device in accordance with some embodiments of the present disclosure;

FIG. 3 shows a flowchart illustrating method of determining an effort index of a user in learning a concept in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for determining an effort index of a user in learning a concept. The system may provide a content associated with a concept to the user. As an example, the concept may be related, but is not limited to, “leadership skill”, “business management”, “business development”, “marketing skills”, “Artificial Intelligence”, “Robotics”, “machine learning” and the like. The concepts may be defined by an organization comprising group of users. The content may be in the form of at least one of text, video, audio and images. Upon providing the content, the system may provide predefined number of questions associated with the content. When the content is being viewed by the user, the system may monitor one or more first parameters. As an example, the one or more first parameters may include, but is not limited to, monitoring whether the video is completely watched by the user, monitoring whether the user spends a first predefined time on reading the text and viewing the audio or images. Thereafter, the system may identify a parameter value for each of the one or more first parameters. The parameter value may be identified based on a first predefined constant value associated with each of the one or more first parameters and a binary value assigned for each of the first one or more parameters. The binary value is assigned based on monitoring of each of the one or more first parameters. The binary value may be “1” or “0”. As an example, if the user has completely watched the video, then the binary value may be “1”. If the user may not watch the video completely, then the binary value may be “0”. Once the parameter value for each of the one or more first parameters are identified, the system may identify a total parameter value based on the parameter value of each of the one or more first parameters.

Once the content is viewed by the user, the user may be provided with predefined number of questions. In an embodiment, the system may monitor one or more second parameters when the user is providing answer for each of the predefined number of questions to assess whether the user has completely reviewed and understood the content. As an example, monitoring the one or more second parameters may include, but is not limited to, identifying predefined number of questions for which time consumed to provide answer is greater than or equal to a second predefined time, identifying predefined number of questions for which time consumed to provide answer is less than the second predefined time, identifying predefined number of questions for which number of attempts made to answer is less than a first threshold value and identifying the predefined number of questions for which number of attempts made to answer is greater than the first threshold value. The system may identify a factor value for each of the one or more second parameters. The factor value may be based on a second predefined constant value and a first value identified for each of the one or more second parameters. The first value is the predefined number of questions identified based on monitoring of each of the one or more second parameters. Thereafter, the system may identify total factor value based on factor value of each of the one or more second parameters.

In an embodiment, the system may monitor one or more third parameters associated with the predefined number of questions provided to the user. The one or more third parameters may include, but is not limited to, monitoring if the video is watched by the user while answering one or more predefined number of questions and monitoring whether the user has provided correct answers for predefined number of questions. Based on the monitoring of the one or more third parameters, the system may identify a total reward value for the user. Thereafter, the system may determine effort index indicating effort of the user in learning the concept based on the total parameter value, total factor value, a predefined effort index value associated with the user and the total reward value. In this manner, the present disclosure provides a method and system for accurately monitoring effort put by the user in understanding concepts.

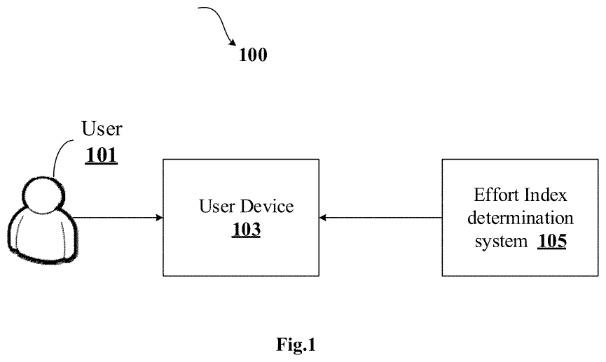

FIG. 1 shows an exemplary environment for determining effort index of a user in learning a concept in accordance with some embodiments of the present disclosure.

The architecture 100 may include a user 101, a user device 103 and an effort index determination system 105 [also referred as system]. The user 101 may be associated with the user device 103. As an example, the user device 103 may include, but is not limited to, a computer, a mobile device, a tablet and any other electronic device capable of receiving and transmitting data. As an example, the user may be a user of the organization who is learning a concept and using the effort index determination system 105. In an embodiment, the effort index determination system 105 may be provided in the user device 103 as an application. In another embodiment, the effort index determination system 105 may be associated with the user device 103 through a communication network [not shown in FIG. 1] or the system 105 may be hosted in a cloud server. In this scenario, the system 105 may remotely monitor activities of the user 101 in the user device 103 to determine effort index of the user 101 associated with the user device 103. The system 105 may be configured to determine effort index of the user 101 in learning a concept. The effort index may be a measure of effort put by the user 101 in learning a concept. As an example, the concept may be related, but is not limited to, “leadership skill”, “business management”, “business development”, “marketing skills”, “Artificial Intelligence (AI)”, “machine learning”, “robotics” and the like. The concept may be defined by an organization. As an example, the organization may include, but is not limited to, an educational institution and a business organization and any other organization involving group of people in performing strategic objectives of the organization.

The effort index determination system 105 may provide a content associated with a concept to the user device 103 associated with the user 101. The content may be in the form of at least one of text, audio, video and images. As an example, a business organization may wish provide training to its employees on “leadership skills”. Therefore, the training may include providing a video explaining the leadership skills to the employees. Once the content is provided, the system 105 may provide a predefined number of questions associated with the content. As an example, the system 105 may provide “5” questions associated with the content. The questions may be provided to analyze/understand, based on the answers provided by the user 101, if the user 101 has reviewed and understood the content.

In an embodiment, the system 105 may monitor one or more first parameters when the content is being viewed by the user 101. The one or more first parameters, may include, but is not limited to, whether the video is completely watched by the user 101, monitoring whether the user 101 spends a first predefined time on reading the text and viewing audio or images. As an example, the first predefined time may be “4” seconds. The system 105 may monitor to identify if the user 101 has spent “4” seconds to understand content in each frame provided in the video. For each of the one or more first parameters, the system 105 may assign a binary value. The binary value may be “1” or “0”. If the user 101 has completely watched the video, then the system 105 may assign a binary value “1”. If the user 101 has not watched the video completely and switches to some other task in between, the system 105 may assign the binary value “0”. Further, the system 105 may assign a binary value “1” if the user 101 spends a first predefined time, as an example, “4” seconds on reading the text and viewing audio/images in each frame of the video and the system 105 may assign a binary value “0” if the user 101 may not spend the first predefined time “4” seconds on reading the text and viewing audio or images in each frame of the video. For each of the one or more first parameters, the system 105 assign a binary value and a first predefined constant value and determine the parameter value. As an example, the first predefined constant value may be −0.75. Thereafter, the system 105 may determine a total parameter value for all of the one or more first parameters based on the parameter value of each of the one or more first parameters.

In an embodiment, when each of the one or more first parameters are monitored and a total parameter value for all of the one or more first parameters is determined, the system may provide predefined number of questions for the user. Further, in an embodiment, the system 105 may monitor one or more second parameters when the user 101 is providing answers for each of the predefined number of questions to assess if the user has reviewed and understood the content. The one or more second parameters may include, but is not limited to, identifying predefined number of questions for which time consumed by the user 101 to provide answer is greater than or equal to a second predefined time, identifying predefined number of questions for which time consumed by the user 101 to provide answer is less than the second predefined time, identifying predefined number of questions for which number of attempts made to answer is less than a first threshold value and identifying the predefined number of questions for which number of attempts made to answer is greater than the first threshold value. As an example, the second predefined time may be “4” seconds and the first threshold value may be “2”. The system 105 may identify a factor value for each of the one or more second parameters. The factor value may be based on a second predefined constant value and a first value identified for each of the one or more second parameters. The first value may be the number of questions among the predefined number of questions identified based on monitoring of each of the one or more second parameters. As an example, for “3” questions among the “5” questions, the user 101 may consume less than “4” seconds, therefore, the first value may be “3”. Similarly, for 2 questions among the “5” predefined questions, the user 101 may take more than 2 attempts to answer the question and hence the first value may be 2. Similarly, for each second parameter, the first value is identified based on the predefined number of questions. In an embodiment, based on the factor value of each of the one or more second parameters, the system 105 may identify a total factor value.

Further, the system 105 may identify a total reward value for the user 101 based on monitoring of one or more third parameters. The one or more third parameters may include, but is not limited to, identifying if the video is watched by the user 101 while answering one or more predefined number of questions and monitoring whether the user 101 has provided correct answers for predefined number of questions. Thereafter, the system 105 may identify the effort index for the user 101 based on the total parameter value, the total factor value, a predefined effort index value associated with the user 101 and the total reward value. The Predefined Effort Index (PEI) value may be a base or a reference effort value provided to each user 101 learning a similar concept and the PEI may be same for all of the users learning the similar concept. As an example, the PEI value may be “5”. The effort index may indicate effort put by the user 101 in learning the concept. Once the effort index is identified, the system 105 may compare the effort index identified for group of users learning a similar concept for performing one or more actions such as undertaking one or more strategic decisions by the organization. The organization may also be able to understand if the training is utilized by the users in an effective manner based on the effort index.

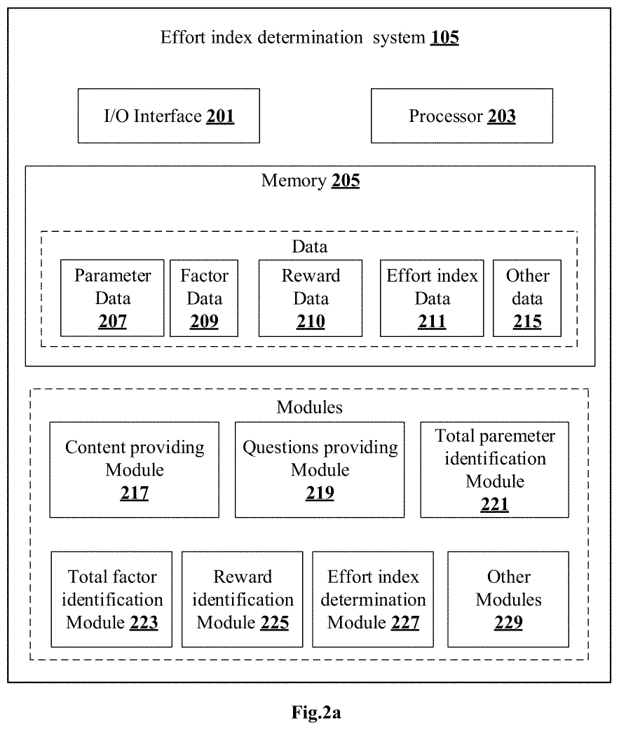

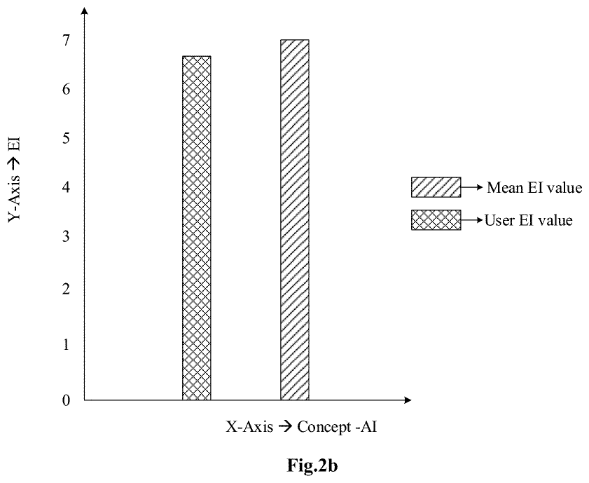

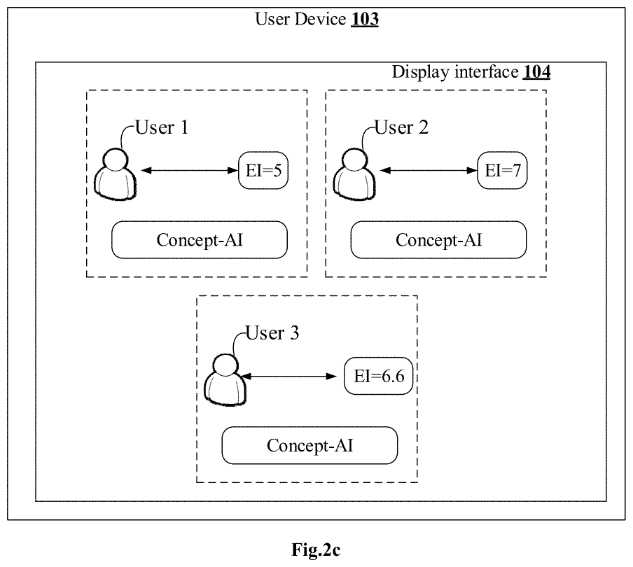

FIG. 2a shows a block diagram of an effort index determination system in accordance with some embodiments of the present disclosure.

In some implementations, the effort index determination system 105 may include an I/O interface 201 and a processor 203. The I/O interface 201 may be configured to provide questions and receive answers. The processor 203 may be configured to perform the functionalities of the system 105. The system 105 may also include data and modules. As an example, the data is stored in a memory 205 configured in the effort index determination system 105 as shown in the FIG. 2a. In one embodiment, the data may include parameter data 207, factor data 209, reward data 210, effort index data 211 and other data 215. In the illustrated FIG. 2a modules are described herein in detail.

In some embodiments, the data may be stored in the memory 205 in form of various data structures. Additionally, the data can be organized using data models, such as relational or hierarchical data models. The other data 215 may store data, including temporary data and temporary files, generated by the modules for performing the various functions of the effort index determination system 105. As an example, the other data 215 may include data associated with predefined threshold values and predefined time.

In some embodiments, the data stored in the memory 205 may be processed by the modules of the effort index determination system 105. The modules may be stored within the memory 205. In an example, the modules communicatively coupled to the processor configured in the effort index determination system 105 may also be present outside the memory 205 as shown in FIG. 2a and implemented as hardware. As used herein, the term modules may refer to an Application Specific Integrated Circuit (ASIC), an electronic circuit, a processor (shared, dedicated, or group) and memory 205 that execute one or more software or firmware programs, a combinational logic circuit, and/or other suitable components that provide the described functionality.

In some embodiments, the modules may include, for example, a content providing module 217, a questions providing module 219, a total parameter identification module 221, a total factor identification module 223, a reward identification module 225, an effort index determination module 227 and other modules 229. The other modules may be used to perform various miscellaneous functionalities of the effort index determination system 105. It will be appreciated that such aforementioned modules may be represented as a single module or a combination of different modules.

Furthermore, a person of ordinary skill in the art will appreciate that in an implementation, the one or more modules may be stored in the memory 205, without limiting the scope of the disclosure. The said modules when configured with the functionality defined in the present disclosure will result in a novel hardware.

In an embodiment, the content providing module 217 may be configured to provide content to the user 101. The content may be provided to the user device 103 associated with the user 101. The content may be defined by an organization. As an example, the organization may include, but is not limited to, an educational institution and a business organization. As an example, the content may relate, but is not limited to, “leadership skill”, “business management”, “business development”, “marketing skills”, “natural language processing”, “machine learning” and “Artificial Intelligence” and “robotics”. The content may be provided in the form of at least one of image, text, audio and video. As an example, the content providing module 217 may provide the content related to “AI”.

In an embodiment, the questions providing module 219 may be configured to provide predefined number of questions associated with the content. The predefined number of questions may be provided in order to assess whether the user 101 has understood the content rightly. As an example, “5” predefined number of questions may be provided such as “what is AI”, “How many types of AI”, “name 5 uses of AI”, “name five examples of AI” and “name 5 applications of AI”.

In an embodiment, the total parameter identification module 221 may be configured to identify total parameter value. The total parameter value may be based on parameter value of each of one or more first parameters. When the content is being viewed by the user 101, the total parameter identification module 221 may monitor one or more first parameters. As an example, there may “two” first parameters P1 and P2. The first parameter P1 may be monitoring whether the video is completely watched by the user 101 and the first parameter P2 may be monitoring whether the user 101 spends a first predefined time on reading the text and viewing audio or images. In an embodiment for each of the one or more first parameters, a parameter value may be assigned based on the first predefined constant value and the binary value. If the video is watched completely by a user 101, then the total parameter identification module 221 may assign the binary value 1. As an example, the first predefined time may be “4” seconds. As an example, the video related to “AI” may be completely watched by the user 101 and hence the binary value “1” may be assigned. Similarly, the user 101 may spend “4” seconds in reading the text and viewing audio or images in each frame of the video associated with the content and hence the binary value “1” may be assigned. Each of the one or more first parameters is associated with a first predefined constant value. As an example, the first predefined constant value may be −0.75. The parameter value (P) may be determined based on the equation 1 as shown below.

Parameter Value (PV)=First predefined constant value*Binary value Equation 1

The Parameter Value (PV1) associated with the first parameter (P1)=−0.75*1=−0.75
The Parameter Value (PV2) associated with first parameter (P2)=−0.75*1=−0.75

In an embodiment, the Total Parameter (TP) value may be identified based on the Parameter Value (PV) associated with each of the one or more first parameters, P1 and P2. The TP value may be stored as the parameter data 207 in the memory 205 of the system 105. The TP value may be identified based on the equation 2 as shown below.

Total Parameter (TP) value=PV1+PV2 Equation 2

Total Parameter (TP) value=−0.75+(−0.75)=−1.5

In an embodiment, once the TP value is identified for each of the one or more first parameters, the system 105 may provide predefined number of questions to the user 101. Based on the answers provided by the user 101 for the predefined number of questions and by monitoring the one or more second parameters while the answers are provided by the user, the system 105 may assess whether the user 101 has completely reviewed and understood the content.

In an embodiment, the total factor identification module 223 may be configured to identify total factor value. The total factor value may be based on factor value associated with each of the one or more second parameters. Each of the one or more second parameters may be monitored when the user 101 is providing answers for the predefined number of questions. As an example, there may be “four” second parameters, SP1, SP2, SP3 and SP4. The SP1 may be identifying predefined number of questions for which time consumed to provide answer is greater than or equal to a second predefined time. The SP2 may be identifying predefined number of questions for which time consumed to provide answer is less than the second predefined time. The SP3 may be identifying predefined number of questions for which number of attempts made to answer is less than a first threshold value and SP4 may be identifying the predefined number of questions for which number of attempts made to answer is greater than the first threshold value. As an example, the second predefined time may be “4” seconds and the first threshold value may be “2”. The factor value may be identified based on a second predefined constant value associated with each of the one or more second parameters and the first value identified for each of the one or more second parameters. As an example, the second constant value may be 0.1 for SP1 and SP3 and the second constant value may be −0.4 for SP2 and SP4. The first value may be the predefined number of questions identified based on the monitoring of each of the one or more second parameters. As an example, for “2” questions among the “5” questions which are “what is AI”, “How many types of AI”, the user 101 may have consumed more than the second predefined time which is “4” seconds to provide the answer. Hence, the first value may be “2”. Similarly, for “3” questions such as, “name 5 uses of AI”, “name five examples of AI” and “name 5 applications of AI”, the user 101 may have consumed less than “4” seconds to provide the answer and hence the first value may be “3”. Further, for “3” questions among the “5” questions, which are “what is AI”, “How many types of AI” and “name 5 uses of AI”, the user 101 may have made less than the first threshold value which is “2” attempts to provide the correct answer and hence the first value may be “3 and for “2” questions among the “5” questions which are “name five examples of AI” and “name 5 applications of AI”, the user 101 may have made more than “2” attempts to provide the correct answer and hence the first value may be “2”. In an embodiment, the Factor value (FV) associated with each second parameter may be identified based on the equation 3 below.

Factor Value (FV)=First Value*Second predefined constant value Equation 3

Factor Value (FV1) associated with second parameter (SP1)=2*0.1=0.2
Factor Value (FV2) associated with second parameter (SP2)=3*−0.4=−1.2
Factor Value (FV3) associated with second parameter (SP3)=3*0.1=0.3
Factor Value (FV4) associated with second parameter (SP4)=2*−0.4=0.8

In an embodiment, the Total Factor (TF) value may be identified based on the FV associated with each of the one or more second parameters, SP1, SP2, SP3 and SP4. The TF value may be stored as the factor data 209 in the memory 205 of the system 105.

The total factor (TF) value may be based on the equation 4 as shown below.

Total factor (TF) value=FV1+FV2+FV3+FV4 Equation 4

Total factor (TF) value=0.2−1.2+0.3+0.8=0.1
In an embodiment, the reward identification module 225 may be configured to identify the reward value associated with the user 101. The reward value may be identified based on monitoring of the one or more third parameters associated with the predefined number of questions. As an example, there may be “two” third parameters TP1 and TP2. The TP1 may be if the video is watched by the user 101 while answering the one or more predefined number of questions and TP2 may be monitoring whether the user 101 has provided correct answers for the predefined number of questions. As an example, when the user 101 is answering the predefined number of questions the user 101 may watch the content provided initially to the user 101 in order to provide the correct answer. This may indicate that the user 101 is willing to learn the concept in detail and thereafter provide the correct answer. Hence, a binary value 1 may be assigned. However, if the user 101 does not watch the content again while providing answers to the predefined number of questions, then the reward identification module 225 may assign a binary value “0”. Similarly, if the user 101 provides correct answers for predefined number of questions in first attempt itself, then the binary value “1” may be assigned. However, if the user 101 does not provide correct answers for predefined number of questions, then the reward identification module 225 may assign a binary value “0”.

As an example, when the user 101 is providing answer for the third question among the 5 questions, the user 101 may watch the content again and then provide the answer. Therefore, the binary value assigned for the third parameter TP1 is “1”. Further, the user 101 may provide “4” correct answers among the “5” predefined questions in the first attempt. Hence, the binary value assigned for the third parameter TP2 is “1”. The reward identification module 225 may identify the reward value associated with each third parameter based on the binary value and a third predefined constant value. As an example, the third predefined constant value associated with the third parameter TP1 may be “2” and the third predefined constant value associated with the third parameter TP2 may be “1”. The Reward Value (RV) associated with each third parameter may be identified based on the equation 5 below.

Reward Value (RV)=Third predefined constant value*binary value Equation 5.

The reward value (RV1) associated with the third parameter (TP1)=2*1=2
The reward value (RV2) associated with third parameter (TP2)=1*1=1

The Total Reward (TV) value associated with each of the one or more third parameters is identified based on the equation 6 as shown below. The TV value may be stored as the reward data 210 in the memory 205 of the system 105.

Total reward (TR) value=RV1+RV2 Equation 6

### TR=2+1=3

In an embodiment, the effort index determination module 227 may be configured to determine the effort index of the user 101. The effort index may indicate the effort put by the user 101 in learning a concept. The effort index determination module 227 may determine the effort index based on the Total Parameter (TP) value, Total Factor (TF) value, a Predefined Effort Index value (PEI) associated with the user 101 and the Total Reward (TR) value. The predefined effort index value may be a base, or a reference effort value provided to each user 101. As an example, the PEI may be “5”. The effort index may be identified based on the Equation 7 below. The identified effort index may be stored as the effort index data 211.

EI=TP+TF+TR+PEI Equation 7

### EI=−1.5+0.1+3+5=6.6

The below Table 1 shows a detailed view of the calculation involved in identifying the effort index of the user 101.

TABLE 1

| | | First | |
|---|---|---|---|
| One or more First | Binary | predefined | Parameter |
| Parameters | Value | constant value | value (PV) |
| Video is completely watched by | 1 | −0.75 | −0.75 (PV1) |
| the user 101 (P1) | | | |
| User 101 spends a first | 1 | −0.75 | −0.75 (PV2) |
| predefined time on reading the | | | |
| text and viewing audio or | | | |
| images (P2) | | | |

| | | Second | |
|---|---|---|---|
| One or more second | First | predefined | Factor |
| Parameters | Value | constant value | value (FV) |
| Identifying predefined number | 2 | 0.1 | 0.2 (FV1) |
| of questions for which time | | | |
| consumed to provide answer is | | | |
| greater than or equal to a second | | | |
| predefined time (SP1) | | | |
| Identifying predefined number | 3 | −0.4 | −1.2 (FV2) |
| of questions for which time | | | |
| consumed to provide answer is | | | |
| less than the second predefined | | | |
| time (SP2) | | | |
| Identifying predefined number | 3 | 0.1 | 0.3 (FV3) |
| of questions for which number of | | | |
| attempts made to answer is less | | | |
| than a first threshold value (SP3) | | | |
| Identifying the predefined | 2 | −0.4 | 0.8 (FV4) |
| number of questions for which | | | |
| number of attempts made to | | | |
| answer is greater than the first | | | |
| threshold value (SP4) | | | |

| | | Third | |
|---|---|---|---|
| One or more third | Binary | predefined | Factor |
| Parameters | Value | constant value | value (RV) |
| If the video is watched by the | 1 | 2 | 2 (RV1) |
| user 101 while answering the | | | |
| one or more predefined number | | | |
| of questions (TP1) | | | |
| Whether the user 101 has | 1 | 1 | 1 (RV2) |
| provided correct answers for the | | | |
| predefined number of questions | | | |

In an embodiment, the EI may be indicated in a display interface 104 of the user device 103. An exemplary representation of the EI is shown in FIG. 2b. FIG. 2b shows an exemplary bar graph in which X-axis represents the “concept” for which the user 101 is trained and the Y axis represents EI value identified for the user 101. The EI value of the user 101 which is 6.6 is represented in the bar graph. The bar graph also indicates mean EI value. The mean EI value may be obtained based on EI value of plurality of users who are trained for the similar concept. As an example, the mean EI value may be 7. FIG. 2b shows comparative results wherein the EI value of the user 101 may be compared with mean EI value. The comparative results may be used by the organization for performing one or more actions. FIG. 2c shows exemplary representation indicating EI of group of users who are trained for similar concept. As an example, the concept may be AI and three users namely, user 1, user 2 and user 3 may trained for the concept AI. The EI identified for each of the three users are indicated as shown in FIG. 2c. The EI of user 1 is 5. The EI of user 2 is 7 and EI of user is 6.6.

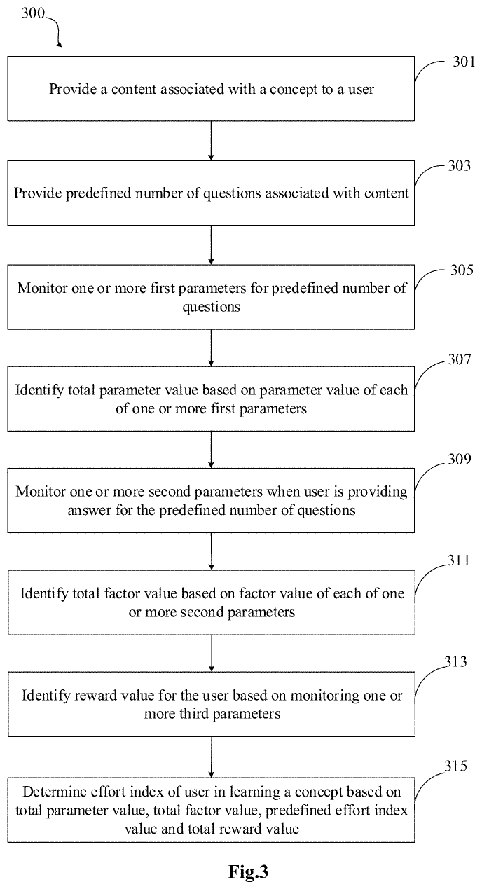

FIG. 3 shows a flowchart illustrating a method for determining an effort index of a user in learning a concept in accordance with some embodiments of the present disclosure.

As illustrated in FIG. 3, the method 300 includes one or more blocks illustrating a method of for determining an effort index of a user 101 in learning a concept. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 may include providing a content associated with a concept to a user 101. The content may be provided to a user device 103 associated with the user 101. The content may be provided in the form of at least one of audio, video, text and images. As an example, the concept may be related, but is not limited to, “leadership skill”, “business management”, “business development”, “marketing skills”, “AI”, “Robotics”, “Machine Learning”, and the like.

At block 303, the method 300 may include providing predefined number of questions associated with the content. The predefined number of questions may be provided in order to assess if the user 101 has completely reviewed and understood the concept associated with the content. As an example, the user 101 may be provided with “5” questions associated with the content.

At block 305, the method 300 may include monitoring one or more first parameters when the content is viewed by the user 101. The one or more parameters may include, but is not limited to, whether the video is completely watched by the user 101 and whether the user 101 spends a first predefined time on reading the text and viewing audio or images in each frame in the video associated with the content. As an example, the predefined time may be “4” seconds.

At block 307, the method 300 may include identifying a total parameter value based on parameter value of each of the one or more first parameters. For each parameter, the system 105 may identify a parameter value. The parameter value may be based on a first predefined constant value and a binary value assigned for each of the one or more first parameters. The binary value assigned may be “1” if the user 101 completely watches the video associated with the content and if the user 101 spends a first predefined time on reading the text and viewing audio or images associated with the content. The binary value assigned may be “0” if the user 101 does not completely watch the video associated with the content and if the user 101 does not spend a first predefined time on reading the text and viewing audio or images associated with the content.

At block 309, the method 300 may include monitoring one or more second parameters when the user 101 is providing answers for each of the predefined number of questions. Monitoring the one or more second parameters may comprise identifying predefined number of questions for which time consumed to provide answer is greater than or equal to a second predefined time, identifying predefined number of questions for which time consumed to provide answer is less than the second predefined time, identifying predefined number of questions for which number of attempts made to answer is less than a first threshold value and identifying the predefined number of questions for which number of attempts made to answer is greater than the first threshold value. As an example, the second predefined time may be “4” seconds and the first threshold value may be “2”.

At block 311, the method may include identifying a total factor value based on factor value for each of the one or more second parameters. The system 105 may identify a factor value for each of the one or more second parameters. The factor value may be based on a second predefined constant value and a first value identified for each of the one or more second parameters. As an example, the second predefined constant value may be 0.4 or 0.1. The first value may be the number of questions among the predefined number of questions identified based on monitoring of each of the one or more second parameters.

At block 313, the method may include identifying a total reward value for the user 101 based on reward value associated with monitoring of each of one or more third parameters. The one or more third parameters may include monitoring if the video is watched by the user 101 while answering one or more predefined number of questions and monitoring whether the user 101 has provided correct answers for predefined number of questions.

At block 315, the method may include determining an effort index of the user 101. The effort index may be identified based on the total parameter value, the total factor value, total reward value and a predefined effort index value associated with the user 101. The predefined effort index value may be a base, or a reference effort index value provided to each user 101. As an example, the predefined effort index value may be “5”. The effort index value may indicate effort put by the user 101 in learning the concept.

In an embodiment, once the effort index is identified, the system 105 may compare the effort index identified for group of users learning a similar concept for performing one or more actions which may aid in improving strategic objectives of the organization.

### Computer System

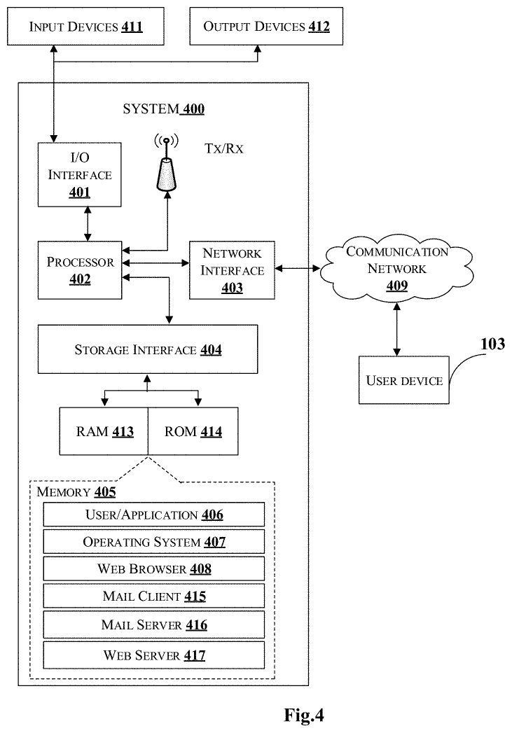

FIG. 4 illustrates a block diagram of an exemplary computer system 400 for implementing embodiments consistent with the present disclosure. In an embodiment, the computer system 400 may be an effort index determination system 105, which is used for determining effort index of a user 101 in learning a concept. The computer system 400 may include a central processing unit (“CPU” or “processor”) 402. The processor 402 may comprise at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412. In some implementations, the I/O interface 401 may be used to connect to a user device 103 to receive answers for predefined questions.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, a web browser 408, mail client 415, mail server 416, web server 417 and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION′ (BSD), FREEBSD™, NETBSD™, OPENBSD™, etc.), LINUX DISTRIBUTIONS' (E.G., RED HAT™, UBUNTU™, KUBUNTU™, etc.), IBM™ OS/2, MICROSOFT′ WINDOWS' (XP™, VISTA™/7/8, 10 etc.), APPLE® IOS™, GOOGLER ANDROID′, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure accurately determines effort index of each user in learning concepts.

In an embodiment, the determination of effort index may aid in undertaking one or more actions on strategic objectives of the organization.

In an embodiment, the present disclosure may determine effort index while the user is reviewing content and providing answers for one or more questions and hence user need not explicitly take up any assessments.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for determining an effort index of a user in learning a concept, the method comprising:
providing a content associated with a concept to the user;
providing a predefined number of questions associated with the content;
monitoring one or more first parameters when the content is being viewed by the user;
identifying a total parameter value based on a parameter value of each of the one or more first parameters and based on a first predefined constant value;
monitoring one or more second parameters when the user is providing answer for each of the predefined number of questions;
identifying a total factor value based on a factor value for each of the one or more second parameters;
identifying a total reward value for the user based on monitoring one or more third parameters associated with the predefined number of questions; and
determining an effort index of the user in learning the concept based on the total parameter value, total factor value, a predefined effort index value associated with the user and the total reward value.

2. The method as claimed in claim 1, wherein the content is in the form of at least one of text, video, audio and images.

3. The method as claimed in claim 2, wherein monitoring the one or more first parameters comprises monitoring whether the video is completely watched by the user, monitoring whether the user spends a first predefined time on reading the text and viewing audio or images.

4. The method as claimed in claim 1, wherein the parameter value of each of the one or more first parameters is based on a first predefined constant value associated with each of the one or more first parameters and a binary value assigned for each of the one or more first parameters, wherein the binary value is assigned based on monitoring of each of the one or more first parameters.

5. The method as claimed in claim 1, wherein monitoring the one or more second parameters comprises identifying predefined number of questions for which time consumed to provide answer is greater than or equal to a second predefined time, identifying predefined number of questions for which time consumed to provide answer is less than the second predefined time, identifying predefined number of questions for which number of attempts consumed to answer is less than a first threshold value and identifying the predefined number of questions for which number of attempts consumed to answer is greater than the first threshold value.

6. The method as claimed in claim 1, wherein the factor value is based on a second predefined constant value and a first value identified for each of the one or more second parameters, wherein the first value is the predefined number of questions identified based on monitoring of each of the one or more second parameters.

7. The method as claimed in claim 1, wherein monitoring the one or more third parameters comprises monitoring if the video is watched by the user while answering one or more predefined number of questions and monitoring whether the user has provided correct answers for predefined number of questions.

8. The method as claimed in claim 1 further comprises comparing effort index identified for each group of users learning a similar concept for performing one or more actions.

9. An effort index determination system for determining effort index of a user in learning a concept, the effort index determination system comprising:
one or more processors; and
a memory communicatively coupled to the processor, wherein the memory stores the processor-executable instructions, which, on execution, causes the processor to:
provide a content associated with a concept to the user;
provide a predefined number of questions associated with the content;
monitor one or more first parameters when the content is being viewed by the user;
identify a total parameter value based on a parameter value of each of the one or more first parameters and based on a first predefined constant value;
monitor one or more second parameters when the user is providing answer for each of the predefined number of questions;
identify a total factor value based on a factor value for each of the one or more second parameters;
identify a total reward value for the user based on monitoring one or more third parameters associated with the predefined number of questions; and
determine an effort index of the user in learning the concept based on the total parameter value, total factor value, a predefined effort index value associated with the user and the total reward value.

10. The effort index determination system as claimed in claim 9, wherein the content is in the form of at least one of text, video, audio and images.

11. The effort index determination system as claimed in claim 10, wherein the processor monitors the one or more first parameters by monitoring whether the video is completely watched by the user, monitoring whether the user spends a first predefined time on reading the text and viewing audio or images.

12. The effort index determination system as claimed in claim 9, wherein the parameter value of each of the one or more first parameters is based on a first predefined constant value associated with each of the one or more first parameters and a binary value assigned for each of the first one or more parameters, wherein the binary value is assigned based on monitoring of each of the one or more first parameters.

13. The effort index determination system as claimed in claim 9, wherein the processor monitors the one or more second parameters by identifying predefined number of questions for which time consumed to provide answer is greater than or equal to a second predefined time, identifying predefined number of questions for which time consumed to provide answer is less than the second predefined time, identifying predefined number of questions for which number of attempts consumed to answer is less than a first threshold value and identifying the predefined number of questions for which number of attempts consumed to answer is greater than the first threshold value.

14. The effort index determination system as claimed in claim 9, wherein the factor value is based on a second predefined constant value and a first value identified for each of the one or more second parameters, wherein the first value is the predefined number of questions identified based on monitoring of each of the one or more second parameters.

15. The effort index determination system as claimed in claim 9, wherein the processor monitors the one or more third parameters by monitoring if the video is watched by the user while answering one or more predefined number of questions and monitoring whether the user has provided correct answers for predefined number of questions.

16. The effort index determination system as claimed in claim 9, wherein the processor compares effort index identified for each group of users learning a similar concept for performing one or more actions.

17. A non-transitory computer readable medium including instructions stored thereon that when processed by at least one processor causes effort index determination system to:
provide a content associated with a concept to the user;
provide a predefined number of questions associated with the content;
monitor one or more first parameters when the content is being viewed by the user;
identify a total parameter value based on a parameter value of each of the one or more first parameters and based on a first predefined constant value;
monitor one or more second parameters when the user is providing answer for each of the predefined number of questions;
identify a total factor value based on a factor value for each of the one or more second parameters;
identify a total reward value for the user based on monitoring one or more third parameters associated with the predefined number of questions; and
determine an effort index of the user in learning the concept based on the total parameter value, total factor value, a predefined effort index value associated with the user and the total reward value.

18. The non-transitory computer readable medium as claimed in claim 17, wherein to monitor the one or more first parameters, the instructions causes the processor to monitor whether video associated with the content is completely watched by the user, monitor whether the user spends a first predefined time on reading text and viewing audio or images in the video.

19. The non-transitory computer readable medium as claimed in claim 17, wherein the instructions causes the processor to identify parameter value of each of the one or more first parameters based on a first predefined constant value associated with each of the one or more first parameters and a binary value assigned for each of the one or more first parameters, wherein the binary value is assigned based on monitoring of each of the one or more first parameters.

20. The non-transitory computer readable medium as claimed in claim 17, wherein to monitor the one or more second parameters, the instructions causes the processor to identify predefined number of questions for which time consumed to provide answer is greater than or equal to a second predefined time, identify predefined number of questions for which time consumed to provide answer is less than the second predefined time, identify predefined number of questions for which number of attempts consumed to answer is less than a first threshold value and identify the predefined number of questions for which number of attempts consumed to answer is greater than the first threshold value.

21. The non-transitory computer readable medium as claimed in claim 17, wherein the instructions causes the processor to identify factor value based on a second predefined constant value and a first value identified for each of the one or more second parameters, wherein the first value is the predefined number of questions identified based on monitoring of each of the one or more second parameters.

22. The non-transitory computer readable medium as claimed in claim 17, wherein to monitor the one or more third parameters, the instructions causes the processor to monitor if the video is watched by the user while answering one or more predefined number of questions and monitor whether the user has provided correct answers for predefined number of questions.
